(19) United States
(12) Patent Application Publication
(10) Pub. No.: US 2008/0168214 A1
(43) Pub. Date: Jul. 10, 2008

(54) MEMORY SYSTEM AND METHOD USING SCRAMBLED ADDRESS DATA

(75) Inventors: Oh-Suk Kwon, Yongin-si (KR); Sung-Soo Lee, Seongnam-si (KR); Dae-Seok Byeon, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 11/969,261

(22) Filed: Jan. 4, 2008

(30) Foreign Application Priority Data
Jan. 4, 2007 (KR) 10-2007-0001055

(51) Int. Cl. G06F 12/02

(52) U.S. Cl. 711/103; 711/E12.008

(57) ABSTRACT

A memory system and a method of provided scrambled address data are disclosed. The method includes converting external address data into row and column addresses provided to a flash memory device, and designating certain scrambled address data values within the external address data and ignoring a current data access operation associated with external address data including a scrambled address data value, such that the plurality of physical pages in each memory block is not selected by the internal address data.

### CROSS-REFERENCE TO RELATED APPLICATIONS

This U.S. non-provisional patent application claims priority under 35 U.S.C. § 119 to Korean Patent Application No. 10-2007-0001055 filed on Jan. 4, 2007, the subject matter of which is hereby incorporated by reference.

### BACKGROUND OF THE INVENTION

1. Field of the Invention

The present invention relates generally to semiconductor memory devices. More particularly, the invention relates to a memory system operated with a method that scrambles address data.

2. Description of the Related Art

Flash memory device is one kind of an Electrically Erasable Programmable Read-Only Memory (EEPROM) in which a plurality of memory regions may be erased or programmed using a single memory system operation. Other types of EEPROM allow only a single memory region to be erased or programmed by a unitary memory system operation. Hence, memory systems incorporating flash memory enjoy an increased operating efficiency over memory systems using other types of EEPROM. However, the constituent memory cells forming a flash memory, like other types of EEPROM, become worn out by a certain number of erase/program operations due to fatigue associated with the dielectric material insulating a charge storing element.

Flash memory is nonvolatile in its operative nature. Thus, stored data may be retained in the absence of applied power. Flash memory also provides excellent immunity to physical impacts and relatively fast data access speeds. Due to these properties, flash memory is extensively used in portable electronic devices running from batteries. Contemporary flash memory comes in two types; NOR flash memory and NAND flash memory—which vary in the nature of the logic gate used in relation to memory cells.

Flash memory may be implemented using an array of memory cells that store a single bit of information per memory cell (SBC), or memory cells that store multiple bits of information per memory cell (MBC).

Figure (FIG.) 1 is a block diagram of a relevant portion of a conventional NAND flash memory device.

Referring to FIG. 1, the illustrated portion of the flash memory device includes a memory cell array 10, a row selector (hereinafter, “an x-selector”) 20, and a data register and sense amplifier (S/A) 30. Memory cell array 10 is implemented with a plurality of memory blocks identified as MB0 through MB(m−1). Each one of the plurality of memory blocks MB0-MB(m−1) is assumed to be substantially similar in its structure for purposes of the present discussion. Each one of the plurality of the memory blocks MB0-MB(m−1) is adapted to store 2N-bit data, where N is a positive integer greater than or equal to 1. X-selector 20 selects one of the plurality of memory blocks MB0-MB(m−1) (e.g., MB0 in the discussion that follows) and one word line within the selected memory block in response to a received row address. S/A 30 is connected to the selected memory block through a bit line, and operates as a write driver during program operations and as a sense amplifier during read operations.

FIG. 2 is a block diagram further illustrating a portion of a selected memory block MB0 and a corresponding portion of S/A 30 shown in FIG. 1.

Referring to FIG. 2, selected memory block MB0 comprises a plurality of strings 11 respectively connected to one of a plurality of bit lines. Here, only a single odd/even pair of bit lines (BLe0 and BLo0) are shown, bit those skilled in the art understand that many bit lines or odd/even bit line pairs may be used to implement selected memory block MB0. Each one of the plurality of strings 11 includes a string select transistor SST, a ground select transistor GST, and a plurality of series connected memory cells MC31 through MC0 disposed between string select transistor SST and ground select transistor GST. The string select transistors SST in strings 11 are commonly connected to the string select line SSL controlled by x-selector 20. The ground select transistors GST in strings 11 are commonly connected to the ground select line GSL controlled by x-selector 20. The plurality of series connected memory cells MC31-MC0 in each string 11 are respectively connected to corresponding word lines WL31 through WL0 controlled by x-selector 20.

S/A 30 includes a bit line selector 31 connected to bit line pair BLe0 and BLo0 and a related register 32. Bit line selector 31 selects one of the bit line pair BLe0 and BLo0 and electrically connects the selected bit line with register 32. Register 32 applies a program voltage (e.g., a ground voltage) or a program inhibit voltage (e.g., a power voltage) to the selected bit line according to the program data specified in relation to a current program operation. Register 32 detects data stored in one or more of the plurality of memory cells through the selected bit line during a current read operation. Although not illustrated in FIG. 2, other bit line pairs are respectively connected to corresponding registers using a similar structure.

Under the assumptions that each word line is associated with two pages (2P) (i.e., an even page and an odd page), and each of the series connected memory cells stores 2 bit data (2B), and each one of the plurality of memory blocks includes 32 word lines (32WL), then each memory block includes 128 pages (32WL*2P*2B).

Further assuming that a row address includes a block address selecting a desired memory block and a page address selecting one or more pages within the selected memory block, it follows that a 7 bit address (hereinafter, referred to as “a first row address”) must be used to select each one of the 128 pages. Further assuming 1024 memory blocks within memory cell array 10, a 10 bit address (hereinafter, referred to as “a second row address”) must be used to select one of the 1024 memory blocks.

Accordingly, address coding is necessary to select all pages in one memory block, and then pages in the next memory block. For example, as illustrated in FIG. 3A, a 7 bit first address A12 to A18 is used to select between 128 pages in each memory block, and a plurality of second address bits A19 to Ai are used to select between memory blocks. When the 7 bit first address is 0000000, a first page OP is selected within a selected memory block. When the 7 bit first address is 1111111, a last page 127P is selected within a selected memory block.

Under these working assumptions, it is convenient to “map” the externally provided address onto a physical address location within the flash memory device. That is, the externally provided address changes into a block address and a page address which includes a row address. However, there are limitations to this process. For example, when storing 3-bit data instead of 2 bit data, each memory block will include 192 pages or (32WL*2P*3B) using the foregoing assumptions otherwise.

When storing the 3-bit data per each memory cell, it is impossible to divide the corresponding address data into a page address and a block address in the manner illustrated above. That is, an 8-bit address is required to select between 192 pages. However, 256 pages may be selected between using an 8-bit address. For this reason, there are “pages” that may be selected by the 8-bit address (e.g., an erroneous 8-bit address) that are not allocated or identified within each memory block.

For example, where a flash memory device stores 2-bit data per memory cell, as illustrated in FIG. 3A, a page address selecting the first/last pages of the first memory block BLK0 is identical to a page address for selecting the first/last page of a second or another memory block. In contrast, where a flash memory device stores 3-bit data per memory cell, as illustrated in FIG. 3B, the page address selecting the first/last pages of the first memory block BLK0 is different from the page address for selecting the first/last page of a second or another memory block. This result precludes the effective mapping of an externally provided address into a page address and a block address for the corresponding flash memory device. That is, when storing 3-bit data per memory cell, it is not possible for address mapping into the constituent memory blocks to be distinguishable from an address mapped into pages. For this reason, a memory controller controlling a flash memory device may require an address conversion table for converting an externally provided address into an internal address applicable to the flash memory device illustrated in FIG. 3B.

### SUMMARY OF THE INVENTION

In one embodiment, the invention provides a method of scrambling address data within a flash memory system comprising a flash controller and a flash memory device storing 2N+1-bit data, where N is a positive integer greater than or equal to one, wherein data stored in the flash memory device is arranged in a plurality of memory blocks, each memory block including a plurality of physical pages, the method comprising; converting external address data received from the flash controller into internal address data operative within the flash memory device, and designating certain scrambled address data values within the external address data and ignoring a current data access operation associated with external address data including a scrambled address data value, such that the plurality of physical pages in each memory block is not selected by the internal address data.

In another embodiment, the invention provides a memory system comprising; a flash controller and a flash memory device storing 2N+1-bit data, where N is a positive integer greater than or equal to one, wherein data stored in the flash memory device is arranged in a plurality of memory blocks, each memory block including a plurality of physical pages, wherein the flash memory device is configured with circuitry converting external address data received from the flash controller into internal address data operative within the flash memory device, wherein certain scrambled address data values within the external address data cause the circuitry to ignore a current data access operation associated with external address data including a scrambled address data value, such that the plurality of physical pages in each memory block is not selected by the internal address data.

### BRIEF DESCRIPTION OF THE DRAWINGS

FIG. 1 is a block diagram of a conventional NAND flash memory device;

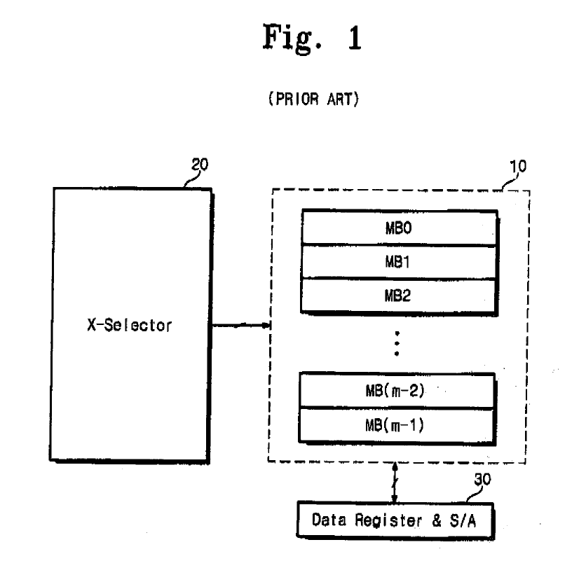

FIG. 2 is a block diagram of a portion of a memory block and corresponding data register & detection amplifier circuit of FIG. 1;

FIG. 3A is a table showing the block and page addresses for a flash memory device storing 2 bit data per memory cell;

FIG. 3B is a table showing the block and page addresses for a flash memory device storing 3 bit data per memory cell;

FIG. 4 is a general block diagram of a memory system according to an embodiment of the invention;

FIG. 5 is a table illustrating an exemplary address scrambling method according to an embodiment of the invention;

FIG. 6 is a table further illustrating the address scrambling method as used between a flash controller and a flash memory device of FIG. 4; and

FIG. 7 is a block diagram further illustrating the flash memory device of FIG. 4.

### DESCRIPTION OF EMBODIMENTS

A flash memory device is used as one example of a non-volatile memory device that may find application in embodiment of the present invention. However, the scope of the invention is not limited to only the flash memory device described or certain illustrative assumptions made in relation thereto. Embodiments of the invention will now be described in some additional detail with reference to the accompanying drawings. The present invention may, however, be embodied in different forms and should not be construed as being limited to only the illustrated embodiments. Rather, the embodiments are presented as a teaching example.

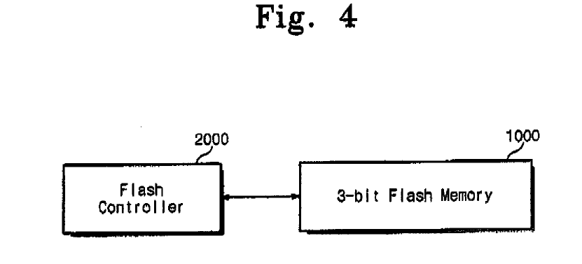

FIG. 4 is a general block diagram of a memory system according to an embodiment of the invention.

Referring to FIG. 4, the memory system comprises a flash memory device 1000 including an array of memory cells adapted to store 3-bit data, and a related flash controller 2000. The illustrated memory system may be used, for example, in relation to memory cards, buffer memories for hard disk drives (HDDs), high capacity memories adapted for use in various computational platforms, etc.

Memory device 1000 is controlled by flash controller 2000, and is presented as an example of a memory device storing “odd-bit data”, or 2N+1-bit data, where N is a positive integer greater than or equal to 1, per memory cell. Flash controller 2000 receives externally provided address data (e.g., from a host device CPU), and converts the “external address data” into “internal address data” suitable for use within memory device 1000 storing 3-bit data.

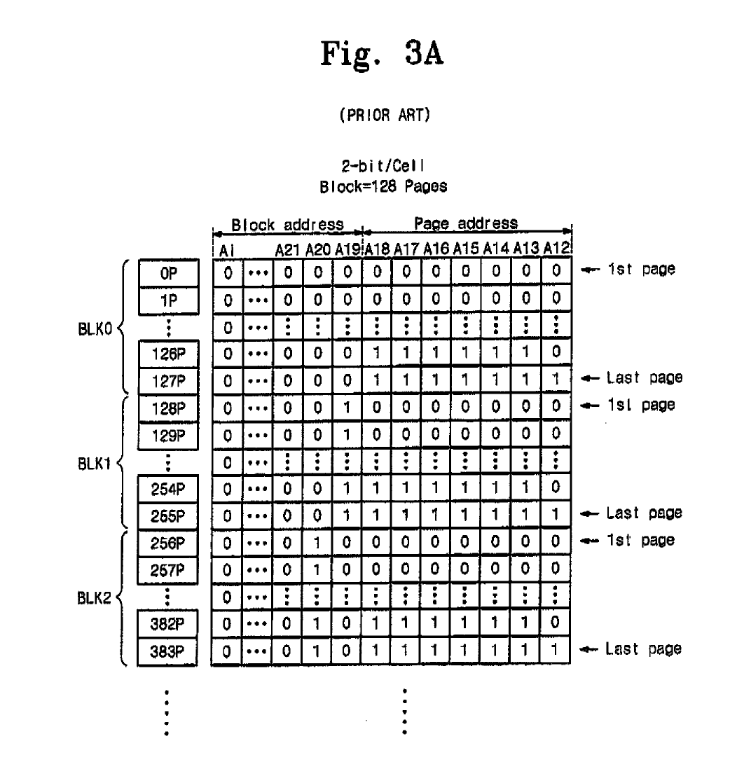

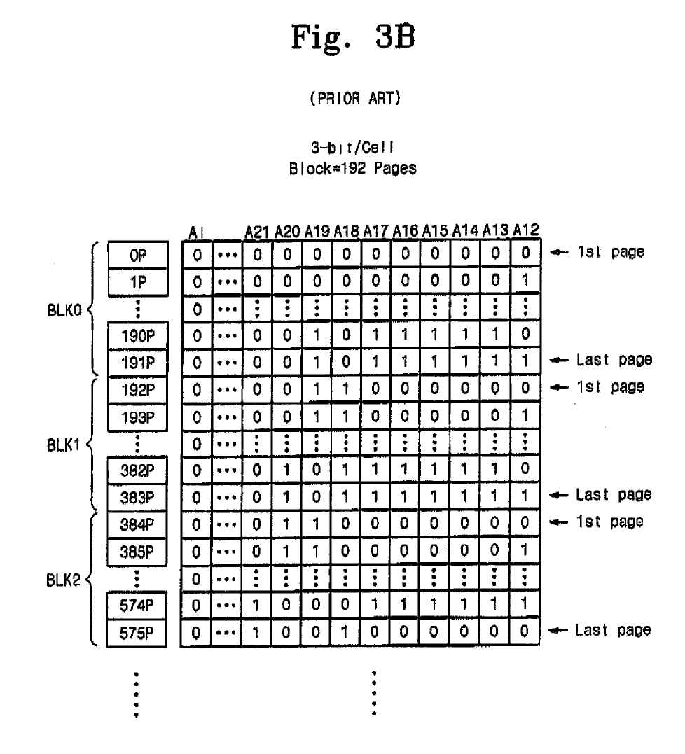

As suggested by the foregoing discussion had in relation to FIG. 3B, conventional memory systems are generally unable to perform an external to internal address data conversion without recourse to a look-up table. However, use of a look-up table is relatively slow and a more efficient solution is provided by embodiments of the invention. Thus, unlike the conventional solution, flash controller 2000 converts the external address data to internal address data (e.g., a page address and a block address) for memory device 1000 storing odd-bit data without the need for an address look-up table facilitating conversion.

In one embodiment of the invention, flash controller 2000 operatively ignores certain external address data when that external address data has a specified scramble value. That is, if external address data has a specified scramble value, the corresponding data access operation to flash memory device 1000 (e.g., a program, read, or erase operation) associated with the “scramble value address data” is simply ignored (e.g., it is considered a no operation or “No-op”). This being the case, the range of scramble value address data must be carefully defined between flash controller 2000 and the external device presenting the corresponding data access operation.

For example, under consistent assumptions given above, flash memory device 1000 stores 3-bit data per memory cell (3B), and includes 32 word lines (32WL), odd/even bit line pairs (2P) provided in each memory block, and each memory block includes 192 pages (32WL*2P*3B). Thus, 8-bit address data must be used to select between the 192 pages. According to an embodiment of the invention, however, at least part (e.g., 2 bits of address data) of the 8-bit address data are scrambled.

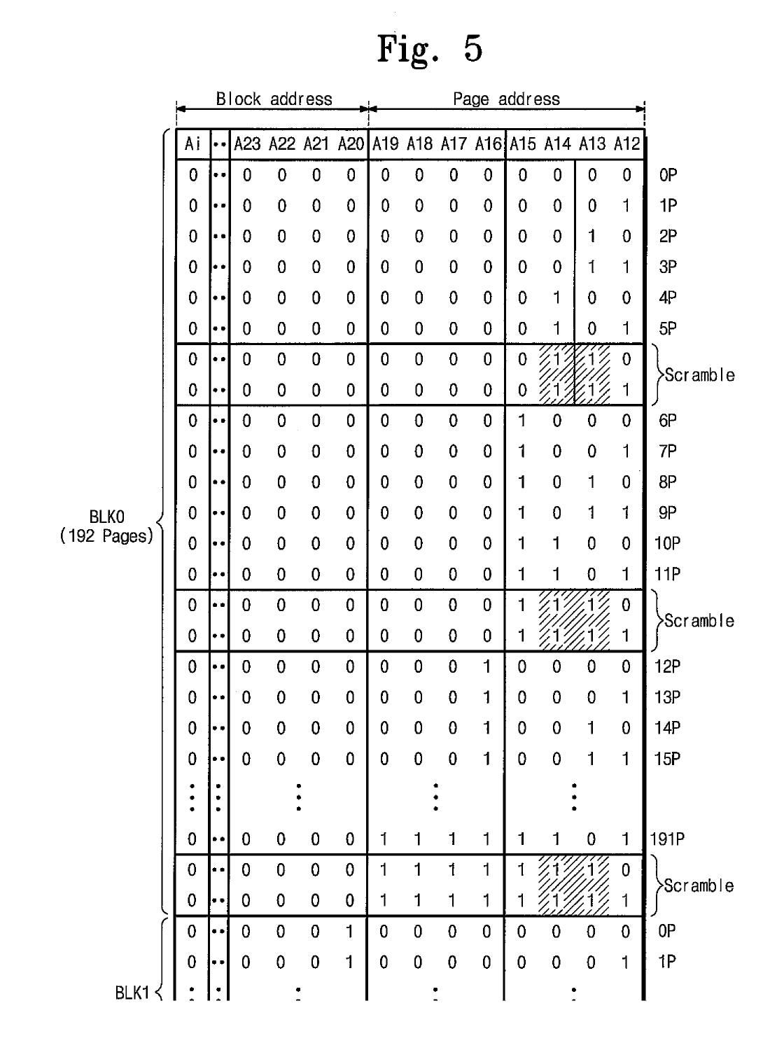

As illustrated in FIG. 5, for example, 8-bit address data (e.g., address bits A12 through A19) is used to select between the 192 pages of each memory block. Here, when external address data simultaneously includes bit values of “1” and “1” for address bits A13 and A14, the corresponding data access operation directed to flash memory device 1000 is ignored. Thus, in this example, external address data including the value “11” for address bits A13 and A14 defined as “scrambled address data values”, and these scrambled address data values are not allocated or mapped into any page.

As a result of this external address scrambling method, 64 pages are scrambled for each memory block. This being the case, it is possible to select 192 pages by using mapped 8-bit external address data. As can be seen from FIG. 5, despite the fact that flash memory device 2000 stores 3-bit data per memory cell, a page address, including address bits A12 through A19 may be used to select the first/last pages of a first memory block BLK0 in identical fashion to selecting the first/last pages of a second (or another) memory block. This means that the external address data has been properly mapped into a page address and a block address for flash memory device 200 without the need for an address look-up table. Accordingly, mapped address data related to memory blocks may be distinguished from mapped address data related to pages.

For other embodiments of the invention, it is apparent to those skilled in the art that the address scrambling method is not limited to flash memory devices storing 3-bit data per memory cell. Additionally, specific scramble values are not limited to only the illustrated address bits (e.g., A13 and A14).

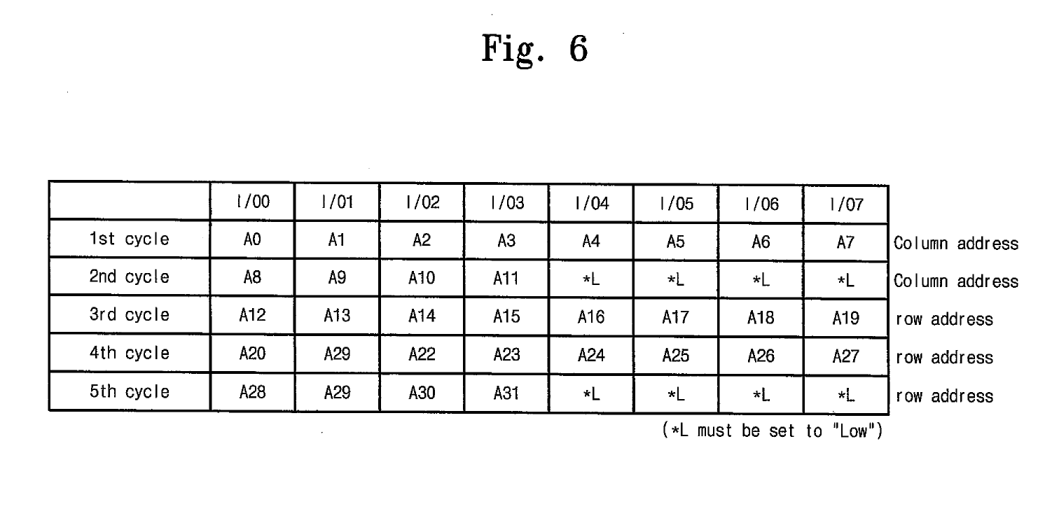

FIG. 6 is a table further illustrating an address scrambling method and related address data as transmitted between the flash controller and flash memory device of FIG. 4.

As is well known in the art, flash memory devices receive address data, command data, and payload data through a collection of input/output (I/O) pins, numbered in the table of FIG. 6. as I/0 0 through I/0 7. Due to the limited number of I/O pins, row and column addresses are divided into data groups and transmitted to the flash memory device over a number of data transmission cycles (e.g., first through fifth). As illustrated in FIG. 6, column address data (e.g., address bits A0 to A11) is provided to flash memory device during the first and second cycles. Row address data (e.g., address bits A12 through A31) is provided to flash memory device during the third through fifth cycles. Row address bits A12 to A31 includes a page address selecting between pages and a block address selecting between memory blocks.

In the illustrated embodiment, because 32 word lines and odd/even bit line pairs are provided in each memory block comprising memory cells storing 3-bit data, each memory block includes 192 pages (32WL*2P*3B). The corresponding page address is 8-bit address data (e.g., A12 to A19) to select between the 192 pages. Address bit A12 is used as information selecting between the odd/even bit lines. Address bits A13 and A14 are used as information to select one of three data bits (or, which may be called first to third page data bits) per each memory. Address bits A15 through A19 are used to select between the 32 word lines in each memory block. However, it will be apparent to those skilled in the art that these address bit assignments are arbitrary and will vary with memory system design.

For example, the page address in addition to the block address may be diversely rearranged. Address bits for selecting one of three data bits may be arranged higher than address bits for selecting word lines. Or, address bits for selecting one of three data bits may be arranged lower than address bits for selecting word lines. Or, address bits for selecting one of three data bits, address bits for selecting a memory block, and address bits for selecting word lines are sequentially provided to the flash memory device.

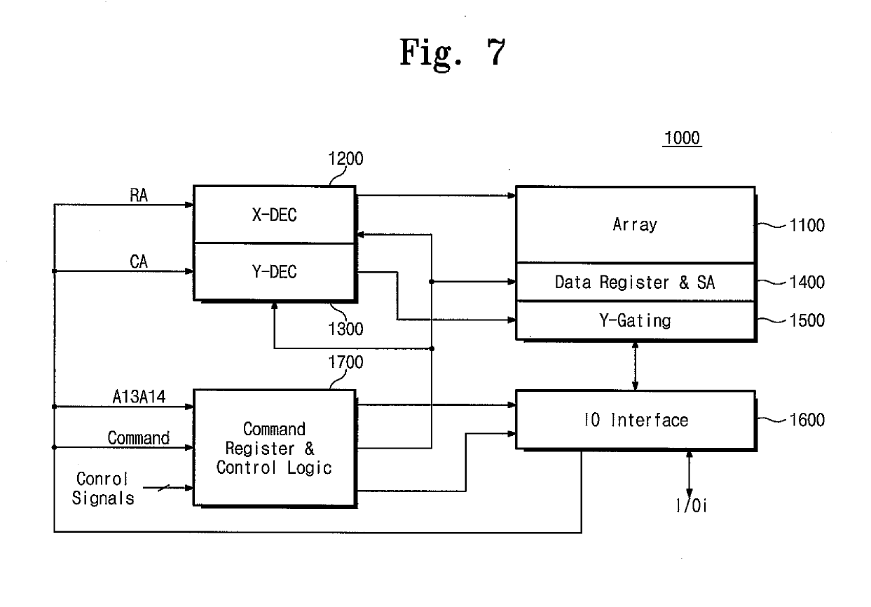

FIG. 7 is a block diagram further illustrating the flash memory system of FIG. 4.

Referring to FIG. 7, flash memory device 1000 comprises a memory cell array 1100, a row decoder circuit 1200, a column decoder circuit 1300, a data register & sense amplifier (S/A) 1400, a column gate circuit 1500, an I/O interface 1600, and a command register & control logic 1700.

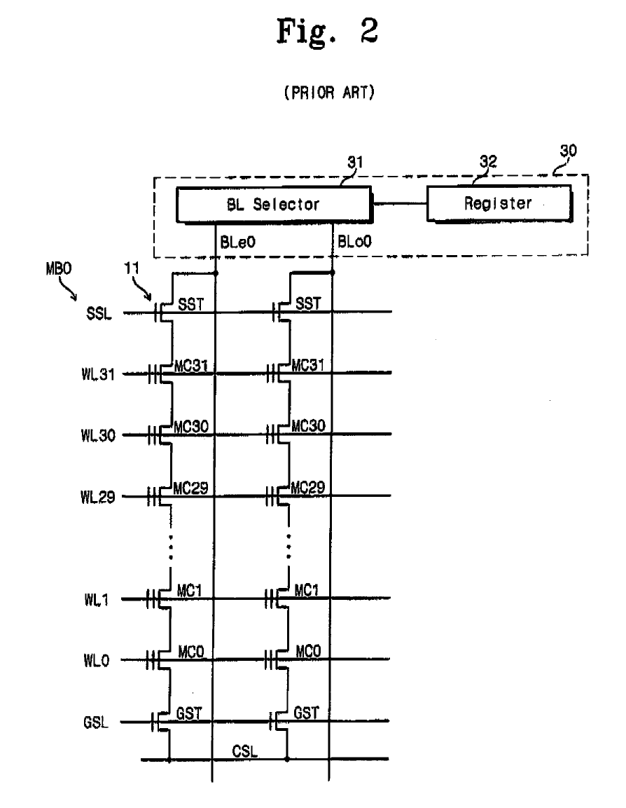

Memory cell array 1100 includes a plurality of memory blocks, and each memory block includes memory cells arranged in an array defined by intersecting word lines and bit lines. The structure of each memory block is assumed to be similar to that described in relation to FIG. 2. Row decoder circuit 1200 selects between pages of memory cell array 1100 in response to a row address provided through I/O interface 1600. Column decoder circuit 1300 decodes a column address CA provided through I/O interface 1600, and then outputs the decoded result to column gate circuit 1500 as column select information. S/A 1400 operates as a sense amplifier during read operations and as a write driver during program operations. S/A 1400 is assumed to have a similar structure to that described in relation to FIG. 2.

Command register & control logic 1700 receives a command from I/O interface 1600 in response to control signals, and controls components of flash memory device 1000 according to an externally provided command. Command register & control logic 1700 receives certain address bits (e.g., A13 and A14) in a row address RA. Command register & control logic 1700 ignores a current data access operation when defined address bits (here, A13 and A14) indicate a scrambled address data value (e.g., 11). Address bits A13 and A14 are also used to select program/read operations directed to one of the first to third page data bits. Due to this, when address bits A13 and A14 have a specific scramble value (e.g., 11), the currently requested operation will not be performed. In contrast, when address bits A13 and A14 do not have a specific scramble value (e.g., 11), the current data access operation is performed in relation to one of the first to third page data bits by command register & control logic 1700.

As described above, even where a memory system stores odd-bit data (e.g., 3-bit data) per memory cell, it is yet possible to effective map external address data into memory blocks in a manner that allows such mapped data to be distinguished from mapped address data related to pages. Because of this, a related flash controller need not make reference to an address look-up table, as is conventional in such circumstances.

The above-disclosed subject matter is to be considered illustrative, and not restrictive, and the appended claims are intended to cover all such modifications, enhancements, and other embodiments, which fall within the scope of the invention. Thus, to the maximum extent allowed by law, the scope of the invention should be determined by the broadest permissible interpretation of the following claims and their equivalents.

What is claimed is:

1. A method of scrambling address data within a flash memory system comprising a flash controller and a flash memory device storing 2N+1-bit data, where N is a positive integer greater than or equal to one, wherein data stored in the flash memory device is arranged in a plurality of memory blocks, each memory block including a plurality of physical pages, the method comprising:
converting external address data received from the flash controller into internal address data operative within the flash memory device; and
designating certain scrambled address data values within the external address data and ignoring a current data access operation associated with external address data including a scrambled address data value, such that the plurality of physical pages in each memory block is not selected by the internal address data.

2. The method of claim 1, wherein the internal address data comprises column address data and row address data, wherein the row address data comprises at least one address bit indicating the scrambled address data values.

3. The method of claim 2, wherein the row address data comprises a page address and a block address, the block address selecting a memory blocks, and the page address selecting one of the plurality of physical pages in the selected memory block.

4. The method of claim 3, wherein the row address data comprises 2M-bit address data, where M is a positive integer greater than or equal to one.

5. The method of claim 3, wherein the page address comprises the at least one address bit indicating the scrambled address data values.

6. The method of claim 5, wherein the at least one address bit indicating the scrambled address data values comprises a first address bit and a second address bit, wherein the first address bit selects one of the 2N+1-bit data stored in a memory cell, and the second address bit selects one of a plurality of word lines in the selected memory block.

7. The method of claim 6, wherein the first address bit is disposed higher than the second address bit in the row address.

8. The method of claim 6, wherein the first address bit is disposed lower than the block address.

9. The method of claim 6, wherein the first address bit is disposed lower than the block address and lower than the second address bit in the row address.

10. The method of claim 6, wherein the first address bit, the block address, and the second address bit are sequentially provided to the flash memory device.

11. A memory system comprising:
a flash controller and a flash memory device storing 2N+1-bit data, where N is a positive integer greater than or equal to one, wherein data stored in the flash memory device is arranged in a plurality of memory blocks, each memory block including a plurality of physical pages,
wherein the flash memory device is configured with circuitry converting external address data received from the flash controller into internal address data operative within the flash memory device, wherein certain scrambled address data values within the external address data cause the circuitry to ignoring a current data access operation associated with external address data including a scrambled address data value, such that the plurality of physical pages in each memory block is not selected by the internal address data.

12. The memory system of claim 11, wherein the internal address data comprises column address data and row address data, wherein the row address data comprises at least one address bit indicating the scrambled address data values.

13. The memory system of claim 12, wherein the row address data comprises a page address and a block address, the block address selecting a memory block, and the page address selecting one of the plurality of physical pages in the selected memory block.

14. The memory system of claim 13, wherein the row address data comprises 2M-bit address data, where M is a positive integer greater than or equal to one.

15. The memory system of claim 13, wherein the page address comprises the at least one address bit indicating the scrambled address data values.

16. The memory system of claim 15, wherein the at least one address bit indicating the scrambled address data values comprises a first address bit and a second address bit, wherein the first address bit selects one of the 2N+1-bit data stored in a memory cell, and the second address bit selects one of a plurality of word lines in the selected memory block.
